(19) United States
(12) Patent Application Publication
(10) Pub. No.: US 2008/0215473 A1
(43) Pub. Date: Sep. 4, 2008

(54) Method for Positively Identifying Livestock and Use Thereof In Legal Instruments Relating Thereto

(76) Inventors: Christopher Cashman, West Chester, PA (US); Robert Mullen, Chester Springs, PA (US); Ronald Cravens, Leawood, KS (US); Clair Gustafson, Bryant, SD (US); Kenneth Odde, Pollock, SD (US); Bruce Van Der Kamp, Centennial, CO (US)

Correspondence Address: HUSCH BLACKWELL SANDERS LLP, 4801 Main Street, Suite 1000, KANSAS CITY, MO, 64112, US

(21) Appl. No.: 11/575,115

(22) PCT Filed: Jan. 23, 2003
(86) PCT No.: PCT/US03/02073

§ 371 Date: Mar. 12, 2007

(51) Int. Cl. G06Q 40/00; A01K 29/00

(52) U.S. Cl. 705/37; 119/174; 705/1; 705/35

(57) ABSTRACT

The present invention comprises a method for identifying individual animals, and for using such identification in the creation of a secured interest therein. It relies on a unique and immutable characteristic of each animal, together with a system for representing such characteristic by a symbolic indicator. The symbolic indicator is used in instruments that create or relate to an interest in the animal, to facilitate subsequent identification of the animal, and execution of the secured interest by the secured creditor and search of recorded interests by third parties.

This application claims priority from an identical United States Provisional Application for Patent Application No. 60/562,131 filed 23 Jan., 2002.

### BACKGROUND OF THE INVENTION

It is common in the agricultural industry to borrow funds to finance the purchase of livestock (including equine and other animals), and the costs of housing, feeding, and caring for such livestock during their development. It is also common for livestock to be purchased by investors who do not operate livestock farms or feedlots, and for the operators of such farms and feedlots to accept livestock from owners for the purpose of housing and feeding them during their development. It has long been of interest to all parties involved in the livestock industry to be able to identify the ownership of particular animals, and various methods have been developed for such identification. In particular, under Uniform Commercial Code Article 9, the revised form of which entered into force in all United States jurisdictions by Jan. 1, 2002 at the latest, filings, whether on paper or electronically, must specifically identify the collateral upon which a secured interest is filed. Heretofore, such identifications as “2 mM head of cattle” were used by secured parties. Such identifications have proven to be insufficiently definite in certain circumstances.

Familiar to viewers of Western movies is the “hot iron” branding of cattle. Using an iron brand bearing a unique symbol representative of an owner or his ranch, each animal is restrained and its hide burned to create a permanent marking. Alternatively, “freeze branding” may also be employed to achieve a similar result. Also familiar to such viewers is the practice of cattle rustlers wherein the brand is overlaid with additional symbol elements to alter the brand, thereby obscuring the ownership indication provided by the original brand. Less familiar to viewers of movies is the trauma caused to the livestock by the branding operation, or the diminution in value of the hide, due to the scarring caused by the brand itself.

Alternatives to branding employed by livestock enterprises include tattooing, ear-notching, dewlap notching, photography, and paint marking of animals. Each has drawbacks including ease of alteration of the identification mark, durability, readability, and the like.

The livestock industry has long sought a superior alternative to branding to identify individual animals within a herd. It has become standard to use an ear tag to identify an animal for herd management and inventory purposes. Metal and plastic tags bearing identification numbers (often consecutively applied using a pliers-like device which applies a stud to pierce the ear of the animal and lock the tag into place, or other similar structures) allow differentiation of the animals for inventory management purposes. Typical of such tags are those available from National Band & Tags of Newport, Ky., USA.

More recently, electronic identification devices (“EID” or radio frequency, “RF-EID”) in ear tags have been considered for use with cattle. Such devices may contain bar or other symbolic codes, and/or an electronic chip containing identification information unique to the tag. The major reason for the use of EID for livestock is for management and tracking of cattle. A newer use for EID is referred to as “safety traceback” and is used in the event of detection of disease in the chain of production and distribution. According to one industry expert, “EID will not prevent or stop a disease but should allow quicker detection/tracing to the source. It should also reduce the total cost of tracing the source of disease by reducing the number of animals to be tested.” (Dr. Emmit L. Rawls, Professor of Agricultural Economics, University of Tennessee)

The cattle industry has been increasingly computerized during the recent past. As one example, the following are the standards and recommendations of the National Cattlemen's Beef Association Cattle Identification Standards Subcommittee, presented at the 2001 Cattle Industry Summer Conference Aug. 5-9, 2001 in Denver, Colo.:
1. Sources of Information
Applying a tag at any stage of production or ownership is not automatic entitlement to any information. Participation and/or agreement between buyers and sellers are necessary to ensure the sharing of information.
Standards: 1. ISO—based Electronic ID Tag.
1. Entire ISO number must be printed on tag. 2. Minimum read range (stationary system) of 30 inches in an active commercial packing environment.

2. Tag must be applied at or before animal leaving herd of origin. 3. EID tag must not be removed except at harvest (packer). 4. Tags must be placed in manufacturer recommended position in the animal's left ear. 5. Tags shall be one-time only and tamper-proof/tamper-evident in design. 6. Producer is responsible for cross-referencing any other identification number that they chose to utilize (American ID Number, Breed Association/Registry number, USDA/government number, etc.).
Recommendations:
1. Failed tags should be replaced with another unique ISO Electronic tag and so noted (and cross-referenced to original tag if possible) in the database.
2. Must be open to adopting other technologies as they become commercially viable.
3. Agreements and Terms of Trade are necessary for sharing and transfer of information from one party to another.
2. Gathering and Submission of Information
For confidentiality purposes, previous ownership(s) identity will not be passed to buyer without agreement or ownership authorization. Standards:
1. When the Information is Gathered and Submitted.
1. Initial data is gathered for all cattle prior to animal leaving herd of origin. 2. Additional data to be added at each change of ownership or premise. 3. Data shall be transferred according to terms of trade or by agreement.
2. Where the Information is Gathered.
1. At each stage of production:
1. Seedstock 2. Cow Calf 3. Market facilities 4. Stocker 5. Feeder/Feedyard 6. Packer
3. What Information is Required.
1. Basic information:
1. Individual Animal ID #: 15 digits including manufacturer/country code (3 digits) and individual animal number (12 digits); (ISO 11784 Standard). 2. Premise Information (Producer Name, Physical and Mailing Address, Phone Number, 3 character alphanumeric field for single or multiple producer defined locations).
4. How the information is gathered.
*All tag readers (stationary and handheld) should be capable of reading tags in accordance with ISO 11785. * All readers must be capable of electronically transferring data to an external computing and storage device.
Recommendations:
1. When
1. Data should be electronically transferred whenever possible.
2. What
1. Additional performance or management data may be collected in accordance with the terms of trade and agreement between buyers and sellers. 2. Producers may reference other premise codes or identifiers into Premise Information. 3. Agreements and Terms of Trade are necessary for sharing and transfer of information from one party to another.
3. How
1. Reader/data collection systems should also have the ability to enter tag data manually.

3. Management of Information

Data exchange and interfacing among data management and software companies is encouraged. Standards:

1. Data remains the property of the cattle owners/stakeholders.

2. Information will be formatted for transmission as follows:
*Producer Name (30 alphanumeric characters)*Producer Mailing Address, consisting of: 1. Street Address (20 alphanumeric characters) 2. City (15 alphanumeric characters) 3. State (2 alpha characters) 4. Zip/Postal Code (9 numeric characters)
1. Producer Physical Address (same definition as Producer Mailing Address 2. Producer Phone Number (15 numeric characters) 3. Producer 3-digit location field (3 alphanumeric characters) 4. Animal EID (15 numeric characters)
Recommendations:
1. Reasonable data security is expected.
2. Time, date, and source stamp of all data entry into system.
1. Databases should have lock-down feature for all data entries.
3. Agreements and Terms of Trade are necessary for sharing and transfer of information from one party to another.

One such EID system is “CattleTrax” available from APEIS Corporation of Norfolk, Nebr., USA. According to APEIS Corporation, the CattleTrax system is a trade secret which is licensed to users, and thus, little information about its operation is known to the present inventors.

Finally, a method for the identification of individual animals and for their tracking has been developed that does not rely solely upon applied brands, tags or the like. The “Optibrand” system, available from Optibrand Ltd., LLC of Ft. Collins, Colo., USA uses a biometric identifier for each animal. According to Optibrand, the characteristics, benefits, and uses of its system are:
Assure food safety;
Provide high quality brand name retail meat products;
Support business-to-business transactions involving livestock;
Support quality assurance claims (e.g., meat is from animals that have never received hormones or antibiotic growth promotants);
Cost-effectively manage businesses all along the production chain; and
Prevent fraud in animal subsidy programs.
The many and differing needs and issues arising from industry, governments and regulatory agencies, producers, and retail establishments require that any successful solution must meet several stringent criteria.
The solution must be based on a unique biometric feature—like a human fingerprint;
Acquisition of the biometric information must be rapid, inexpensive, accurate, not labor intensive and amenable to use by non-skilled workers;
The solution must include information on location as well as identity;
The solution must be tamper-proof;
The method must be humane and, ideally, non-invasive; and

Data must be easily and rapidly transmitted, stored and retrieved.

According to Optibrand, its system “is a combination hand held computer and ocular fundus digital video camera. The camera uses near infrared light to illuminate the ocular fundus of the animal and transmits full motion video at 30 frames per second to the hand held computer using the IEEE1394 protocol (Firewire). The operator sees the full motion video on the handheld computer's LCD display. The firmware and software on the handheld computer search each frame looking for a single frame that it identifies as an acceptable image of the animal's ocular fundus. When an acceptable frame is found, it is presented to the operator for acceptance. The operator makes the final decision to accept or reject the image. To capture an acceptable image, the camera needs to be in the correct position in front of the animal's eye for only 1/30 of a second.” Based on this image, a unique identification of each animal is possible.

Alternatively, DNA testing and type matching, nose printing, ear canal geometries, iris scanning, and facial feature recognition have been suggested as alternative biometric properties that may be used alone, or in combination for the identification of livestock.

In the past, cases of fraud and other legal infraction have come to light in the cattle industry. It has long been recognized that without an adequate way to insure that a particular animal is where it is supposed to be at a particular time, in a secure and auditable manner, fraud will continue to plague the industry. In particular, a bankruptcy of a feedlot operator in Missouri has brought to light the shortcomings of the prior art methods of identification and securitization of cattle. George L. Young declared bankruptcy in August 2001. Investors claimed ownership of 343,937 head of cattle, for which they had paid US$177.6 million. In fact, only 28,784 head of cattle existed. Investors, banks, farmers and commercial feedlots all held liens and secured interests in the cattle, and all stand to lose substantially all of their investment. In turn, lenders have reduced or eliminated their lending to the cattle industry out of fear of continued losses due to such frauds, and thus have implicitly recognized the need for a better system of individual animal identification and securitization.

### BRIEF DESCRIPTION OF THE INVENTION

The present invention comprises a method for positively identifying individual animals, and for using such identification in legal instruments related to the ownership thereof, the creation of a secured interest therein, insurance thereof, or regulatory filing related thereto. It relies on a unique and immutable characteristic of each animal, together with a system for representing such characteristic by a symbolic indicator. The symbolic indicator is then used, for example, in documents related to, or which create a secured interest in the animal, to facilitate subsequent identification of the animal, and execution of the secured interest by the secured creditor.

### DETAILED DESCRIPTION OF THE INVENTION

Using a characteristic that is unique and immutable to each animal, such as a biometric parameter, an animal to be identified is evaluated to determine the unique characteristic. For instance, using the pattern of blood vessels in the retina of the animal, a fundus photograph is procured and evaluated for quality. Alternatively, characteristics such as DNA mapping or other physical characteristics (nose prints, iris scans, etc.) that provide unique results for each individual animal may be determined. Optionally, the time, date and location of the determination, as well as ancillary information such as ear tag or EID information may be allied with the determined physical characteristic or characteristics.

After determination, the unique characteristic(s) are associated with a symbol or symbolic identifier. Preferably, this identifier is an alphanumeric, human-readable character string which is unique to the animal being identified. In concept, this is similar to an automobile's “vehicle identification number (VIN)”, but this “bovine (or biometric) identification number (BIN)” uniquely identifies the animal by its physical characteristic instead of a synthetic code determined during manufacture. This number may also be referred to as an “animal identification number (AIN)” or “cattle/cow identification number (CIN)” or any similar term.

The BIN is thereafter used to identify the animal in documents, such as legal instruments, that create or otherwise describe or relate to a secured interest in the animal. As used herein, the term “instrument” means any document or other record having a legal effect that is related to the animal including, but not limited to financing statements, titles, insurance policies, securities, medical records, regulatory filings, and the like. These documents may be loan notes, UCC-1 Financing Statements, Effective Financing Statements (under UCC-9 or similar statutory authority), or other documents or records, including computerized records. The BINs may also relate to only some individual animals that may be representative of a group of animals, and thus, by a sampling, the entire group may be identified by less than a complete listing of BINs.

Optionally, such documents containing the BIN may be recorded in order to perfect the secured interest, and in certain circumstances, the BIN may be searched, retrieved, and verified by examination of the animal to match the BIN to the animal's physical characteristics.

Other instruments may also be created according to the method of the present invention including, but not limited to documents of title to an animal, insurance documents related to an animal or to a group of animals of which an identified animal is a member, and regulatory filings and records related to an animal or to a group of animals of which an identified animal is a member.

When researching a lien or other interest, of course, UCC or similar records may be searched for the BIN, lending additional security to the parties in a financial transaction. Using BINs, the quality of loans made for livestock is improved (i.e., the risk associated with the loan is lowered.) This improvement may result in an ability to package and resell securities backed by the identified livestock in a secondary market similar to that which exists for mortgage-backed securities.

While the invention has been described in its preferred embodiments, it is to be understood that the words which have been used are words of description rather than of limitation and that changes may be made within the purview of the appended claims without departing from the true scope and spirit of the invention in its broader aspects. The inventors further require that the scope accorded their claims be in accordance with the broadest possible construction available under the law as it exists on the date of filing hereof, and that no narrowing of the scope of the appended claims be allowed due to subsequent changes in the law, as such a narrowing would constitute an ex post facto law, and a taking without due process or just compensation.

We claim:

1. A method for identifying an animal in which a secured interest is to be taken comprising the steps of:
a. Evaluating a unique physical characteristic of the animal;
b. Recording data representative of the unique physical characteristic of the animal;
c. Representing the recorded data in a human-readable form;
d. Referencing the human-readable representation of the recorded data in an instrument that relates to a security interest in the animal.

2. The method of claim 1 wherein the unique physical characteristic is the pattern of vessels in the ocular fundus of one or both eyes of the animal.

3. The method of claim 1 wherein the unique physical characteristic is the DNA of the animal.

4. The method of claim 1 wherein the data recorded is a digital representation of a photograph of the ocular fundus of one or both eyes of the animal.

5. The method of claim 1 wherein the representation of the recorded data is a number.

6. The method of claim 1 wherein the representation of the recorded data is an alphanumeric string.

7. The method of claim 1 wherein the representation of the recorded data is the result of a mathematical algorithm.

8. The method of claim 1 wherein the instrument is a note.

9. The method of claim 1 wherein the instrument is a UCC-1 financing statement.

10. The method of claim 1 wherein the instrument is an Effective Financing Statement.

11. The method of claim 1 further including the step of recording the instrument with a governmental agency.

12. A method researching a security interest in an animal comprising the step of searching the records of a governmental agency to determine whether an identical representation of a physical characteristic of an animal is present in such records.

13. A method for marketing securities backed by interests in livestock that have been secured according to the method of claim 1.

14. A method for identifying an animal in which an ownership interest is to be taken comprising the steps of:
a. Evaluating a unique physical characteristic of the animal;
b. Recording data representative of the unique physical characteristic of the animal;
c. Referencing the recorded data in an instrument that relates to an ownership interest in the animal.

15. A method for identifying an animal in which an insurable interest is to be taken comprising the steps of:
a. Evaluating a unique physical characteristic of the animal;
b. Recording data representative of the unique physical characteristic of the animal;
c. Referencing the recorded data in an instrument that relates to an insurable interest in the animal.

16. A method for identifying an animal for purposes of compliance with a regulation, statute, or rule comprising the steps of:
a. Evaluating a unique physical characteristic of the animal;
b. Recording data representative of the unique physical characteristic of the animal;
c. Referencing the recorded data in a filing or record that relates to a regulation, statute or rule concerning the animal including government requirements for country-of-origin labeling of food products of cattle, sheep and pigs.
